(19) United States
(12) Patent Application Publication
(10) Pub. No.: US 2011/0019432 A1
(43) Pub. Date: Jan. 27, 2011

(54) PROJECTION MODULE FOR A HEADLAMP

(75) Inventor: Matthias Daniel Epmeier, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/934,706

(22) PCT Filed: Apr. 1, 2009
(86) PCT No.: PCT/IB2009/051368

§ 371 Date: Sep. 27, 2010

(30) Foreign Application Priority Data
Apr. 4, 2008 (EP) 08103375.5

(51) Int. Cl. F21V 7/00

(52) U.S. Cl. 362/516

(57) ABSTRACT

The invention relates to a projection module for a headlamp, in particular a motor vehicle headlamp, comprising a light source, which is arranged inside a reflector housing, and which illuminates a projection lens, wherein means are arranged to display a sharp light-dark boundary. The means are integrated into the reflector (2) in such a way that they do not project into the beam path of the light source (1). The invention also relates to a motor vehicle headlamp comprising a projection module of this type.

The invention relates to a projection module for a headlamp, in particular a motor vehicle headlamp, comprising a light source, which is arranged inside a reflector housing, and which illuminates a projection lens, wherein means are arranged to display a sharp light-dark boundary.

Motor vehicle headlamps generally have a reflector and a light source arranged inside the reflector. In this context, halogen or high pressure discharge lamps are used, in particular, as the light source. The reflector surface is illuminated by the emitted light. Depending on the shape of the reflector surface, a headlamp light beam is thus formed, which is radiated to the front.

Various specifications exist for headlamp light beams of this type, high requirements being placed on them. Thus, for example, a low beam has to have an asymmetric light distribution with a substantially horizontal, sharply delimited light-dark boundary, so the oncoming traffic is not dazzled. For example, an illuminance of at least 12 Lux is specified in the axis intersection of the European measuring screen when the low beam is switched on in point 75R, the decisive measuring point for the range of the headlamp. The light-dark boundary runs only half a degree away from this measuring point, beyond which boundary the so-called zone III of glare is located, in which the illuminance may only be at most 0.7 Lux.

Most headlamps consist of so-called projection optical systems. The light emitted from the light source is focused here by means of a reflector onto a screen, which forms the light-dark boundary. The light distribution thus formed is displayed in the traffic area by means of a projection lens. A good headlamp is distinguished by contrast that is as good as possible in the region of the light-dark boundary. The screen allows the light beams emitted by the light source and reflected by the reflector to the lower part of the focal plane of the projection lens to be shaded; said light beams would otherwise be emitted above the light-dark boundary by the headlamp, if the screen were not present.

The screen is regularly a vertical plate with a suitable profile, which is positioned axially between the reflector and projection lens. The contour of this plate is then displayed in the traffic area by means of the projection lens as the light-dark boundary. The drawback in the previously known projection modules is that they take up a considerable amount of installation space.

The invention intends to provide a remedy here. It is an object of the invention to provide a projection module for a headlamp, which has a reduced installation space. According to the invention, this object is achieved by the features of the characterizing part of claim 1.

A projection module for a headlamp, in particular a motor vehicle headlamp, which has a reduced installation space, is provided by the invention.

In a development of the invention, the means are formed by at least one edge of the reflector housing. This makes a particularly compressed mode of construction possible.

In a development of the invention, the at least one edge is light-absorbing. This produces a particularly sharp light-dark boundary. The edge is preferably black.

In a further configuration of the invention, the edge is configured according to the course of the light-dark boundary of a low beam for the road traffic. As a result, a sharp contour of the light-dark boundary is made possible for a low beam with a simultaneously small installation space.

In a further configuration of the invention, an arcuate recess is introduced into at least one edge, the radius of which substantially corresponds to the focal length of the projection lens. This brings about the same spacing of each point of the edge with respect to the projection plane of the lens, thus producing a sharp display of the light-dark boundary thus achieved.

In a development of the invention, the means are formed by at least one substantially horizontal edge, the edge being arranged outside the optical axis of the projection lens. This allows a maximization of the light collected via the reflector housing. A maximum yield of light is produced in the event that the projection lens is arranged centrally with respect to the reflector housing. By integrating the means for displaying the sharp light-dark boundary in the reflector housing, this optimal position is achieved with an arrangement of the edge below the optical axis of the projection lens.

In a further development of the invention, the light source is formed by LEDs. A particularly small installation space for the projection module can be achieved by this. The reflector housing is used as a collimator for the LEDs.

The reflector housing is advantageously configured such that the maximum of the light distribution is produced close to the lower edge. This achieves a high light-dark contrast and therefore a sharp light-dark boundary.

The invention equally extends to a motor vehicle headlamp with an aforementioned projection module.

Other developments and configurations of the invention are disclosed in the remaining sub-claims. An embodiment of the invention is shown in the drawings and will be described in detail hereinafter.

In the drawings:

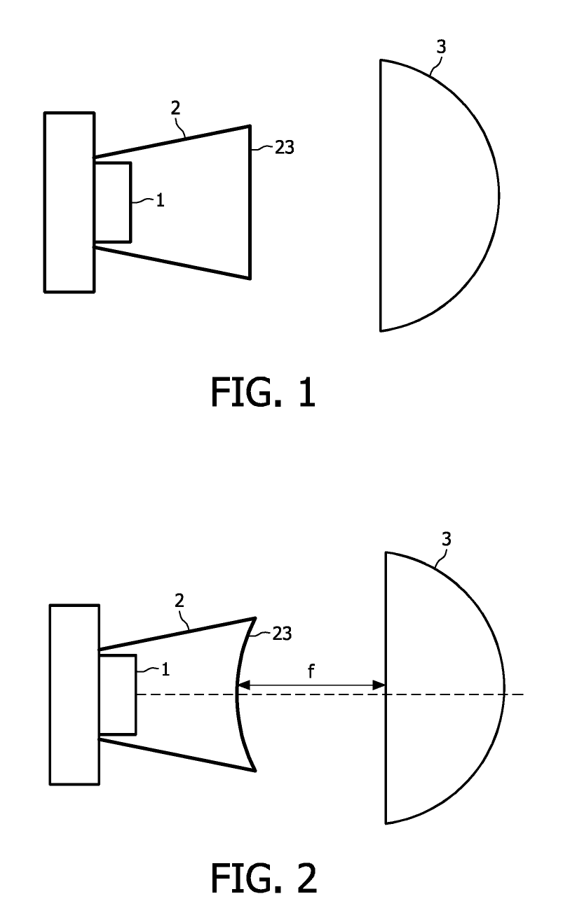

FIG. 1 shows the schematic view of a projection module;

FIG. 2 shows the schematic view of a projection module in a further embodiment;

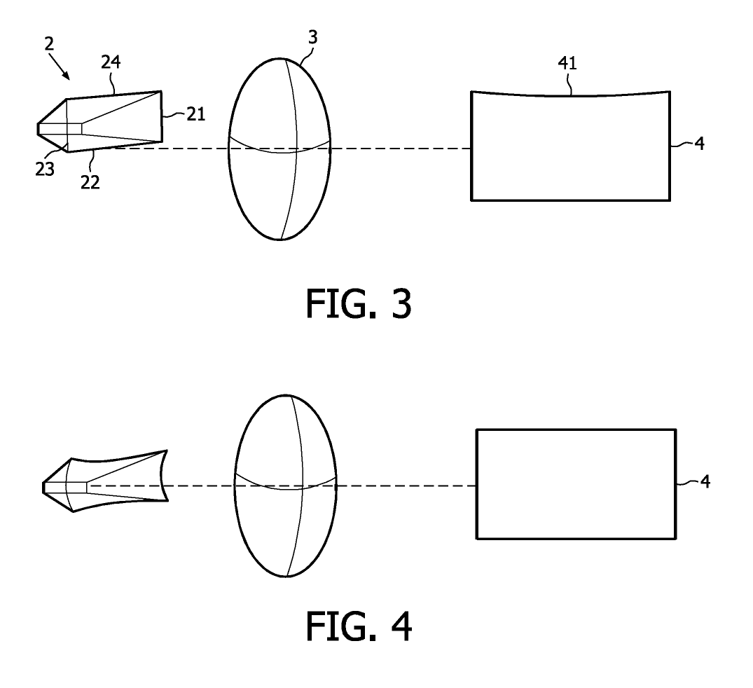

FIG. 3 shows the spatial view of the projection module from FIG. 1 with an illumination pattern;

FIG. 4 shows the spatial view of the projection module from FIG. 2 with an illumination pattern;

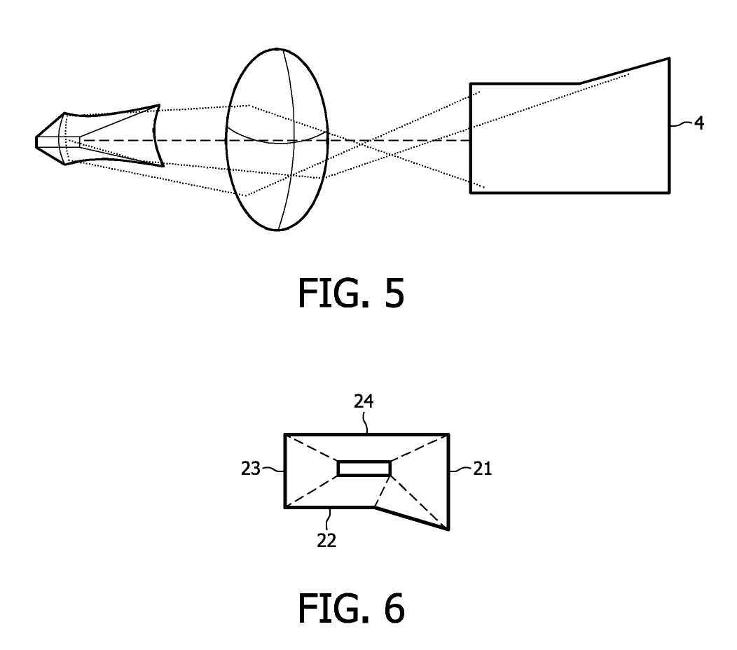

FIG. 5 shows the spatial view of a projection module in a further embodiment with an illumination pattern, and

FIG. 6 shows the view of the reflector module from FIG. 5 from the front.

The projection module selected as the embodiment consists substantially of a light source 1, which is arranged inside a reflector housing 2, as well as a projection lens 3, which is radiated by the light source 1. In the embodiment, the light source 1 is formed by an LED arrangement. The reflector housing 2 surrounds the LED arrangement and is used as a collimator. The collimator 2 is configured such that the light quantity is maximal close to the lower horizontal edge 22, so that this is displayed by means of the lens 3 as the light-dark boundary. The horizontal lower limitation edge 22 of the collimator 2 lies on the centre axis (shown by dashed lines) of the lens 3. The illumination pattern 4 as shown in FIG. 3 is produced. The slight curvature of the upper limitation line 41 of the illumination pattern 4 results from the different geometric spacings of the displayed lower horizontal limitation edge 21 of the collimator 2 from the focal plane of the lens 3. The distortions occurring at the other three sides are less disruptive in use and were therefore ignored.

In the embodiment according to FIG. 4, the limitation edges 21, 22, 23, 24 of the collimator are curved. The radius of curvature corresponds here substantially to the focal length of the projection lens 3. This means that each point of the illuminated limitation edge has the same geometric spacing from the focal plane of the lens 3. The collimator is positioned centrally with respect to the centre axis (shown by dashed lines) of the lens 5, so the lower limitation edge 22 of the collimator 2 is positioned below the centre axis. Accordingly, the illumination pattern 4 shown in FIG. 4 is produced. The upper limitation line 41 does not now have any curvature. Furthermore, more light is received by the lens owing to the central arrangement and made useful for the application.

In the embodiment according to FIG. 5, the collimator from FIG. 4 is modified in such a way that the rear vertical limitation edge 41 of the characteristic light-dark line of the low beam is reproduced. The collimator 2 is provided at its lower edge 22 with a 15° slope to generate the desired light distribution (cf. FIG. 6). The illumination pattern 4 shown in FIG. 5 is produced corresponding to the course of the light-dark boundary of a low beam for the road traffic.

FIG. 6 shows the limitation edges of the collimator, which are provided in the embodiment with a black, light-absorbing color. As a result, an increase in contrast is achieved and the illumination values are produced over the light-dark boundary.

FIG. 5 shows a collimator 2, in which all four edges 21, 22, 23 and 24 are curved. The three sketched light beam courses are used to illustrate the functioning principle. Furthermore, it is possible to configure all the sides of the collimator 2 as complex reflector surfaces to achieve the desired light distribution at the collimator output. A further embodiment can be achieved by shortening or lengthening one or more collimator faces. By lengthening the surface with the edge 24 in the direction of the lens, it is possible to direct still more light in the direction of the lens and thus increase the system efficiency.

In the projection module according to the invention, a separate screen is no longer present; the object of the screen is now taken over by the limitation edges of the collimator 2.

1. A projection module for a motor vehicle headlamp, comprising
a projection lens,
a light source arranged inside a reflector housing for illuminating the projection lens with a beam of light, and
means for displaying a sharp light-dark boundary integrated into the reflector in such a way that they do not project into the beam path of the light source.

2. A projection module as claimed in claim 1, wherein the means are formed by at least one edge of the reflector housing.

3. A projection module as claimed in claim 2, wherein at least one edge is light-absorbing.

4. A projection module as claimed in claim 2, wherein the edge is configured according to the course of the light-dark boundary of a low beam for the road traffic.

5. A projection module as claimed in claim 2, wherein an arcuate recess is introduced into at least one edge, the radius of which substantially corresponds to the focal length of the projection lens.

6. A projection module as claimed in claim 1, wherein the means are formed by at least one substantially horizontal edge, the edge being arranged outside the optical axis of the projection lens.

7. A projection module as claimed in claim 1, wherein the light source comprises one or more LEDs.

8. A projection module as claimed in claim 1, wherein the reflector housing is configured such that the maximum of the light distribution is produced close to the lower edge.

9. A motor vehicle headlamp, comprising a projection module as claimed in claim 1.
